(19) United States
(12) Patent Application Publication
(10) Pub. No.: US 2022/0179151 A1
(43) Pub. Date: Jun. 9, 2022

(54) OPTICAL WAVEGUIDE AND MANUFACTURING METHOD THEREOF

(71) Applicant: Nippon Telegraph and Telephone Corporation, Tokyo (JP)

(72) Inventors: Yuji Fujiwara, Musashino-shi, Tokyo (JP); Satomi Katayose, Musashino-shi, Tokyo (JP); Ryoichi Kasahara, Musashino-shi, Tokyo (JP)

(21) Appl. No.: 17/299,725

(22) PCT Filed: Dec. 5, 2019
(86) PCT No.: PCT/JP2019/047564

§ 371 Date: Oct. 18, 2021

(30) Foreign Application Priority Data
Dec. 18, 2018 (JP) 2018-236671

(51) Int. Cl. G02B 6/122; G02B 6/136; G02B 6/132; G02B 6/12

(52) U.S. Cl. CPC G02B 6/122; G02B 6/12004; G02B 6/132; G02B 6/136

(57) ABSTRACT

There is provided an optical wavelength suppressed in sinking of the core layer into the underlying cladding layer in the heat treatment of the manufacturing process, thereby enabling the reduction of the loss of the visible light waveguide, and suppressed in variations in the substrate plane in the optical waveguide shape. The optical waveguide includes: a substrate, an underlying cladding layer formed on the substrate, an etching stopping layer formed on the underlying cladding layer, a core layer formed on the etching stopping layer, and an overlying cladding layer formed on the core layer and the etching stopping layer. The optical waveguide is characterized in that the etching stopping layer includes a material having a smaller etching rate than that of a material forming the core layer, and having a higher softening point than that of the material forming the core layer.

### TECHNICAL FIELD

The present invention relates to an optical waveguide and a manufacturing method thereof. More particularly, it relates to an optical waveguide suppressed in sinking of the core layer of the optical waveguide into the underlying cladding layer by the heat treatment of the manufacturing process, thereby enabling the reduction in the loss of a visible light waveguide, and a manufacturing method thereof. Along with this, the present invention relates to an optical waveguide with suppressed variations on the substrate plane in the shape of a visible light waveguide due to the microloading effect or the distribution within the substrate plane of the etching amount, thereby being capable of implementing the uniformization within the substrate plane of the waveguide structure, and a manufacturing method thereof.

### BACKGROUND ART

Conventionally, a planar lightwave circuits: PLC formed of a quartz-based glass material (which will be referred to as a quartz-based PLC) has been used mainly for an optical communication/optical signal processing system. The quartz-based waveguide forming a quartz-based PLC is designed and manufactured for communication wavelength. For the core material therefor, SiO₂—GeO₂ obtained by doping SiO₂ with GeO₂ is used. (see, e.g., PTL 1). When SiO₂—GeO₂ is used as the core material of the quartz-based waveguide, a very low loss is caused without a large absorption loss in the communication wavelength band, and an established optical waveguide can be manufactured.

In recent years, a quartz-based PLC device has been used not only for an optical communication/optical signal processing system, but also as an image/sensor device. A quartz-based PLC device designed for a visible light wavelength has also been developed.

However, although SiO₂—GeO₂ for use as the core material of a quartz-based waveguide does not have an absorption in the communication wavelength band, it has an absorption in the visible light wavelength band. For this reason, when a visible light is input to a quartz-based PLC device and propagates through the waveguide, the optical absorption caused by electron excitation undesirably results in the deterioration of the optical characteristics.

Thus, there is a method not using a dopant but using pure quartz glass as the core material of the optical waveguide for visible light. When pure quartz glass is used as the core material of the optical waveguide for visible light, quartz glass doped with boron or fluorine is used as the cladding material in order to reduce the refractive index of the cladding layer to be lower than the refractive index of pure quartz glass.

FIG. 1 shows a conventional optical waveguide structure having a cladding layer using quartz glass doped with boron or fluorine. FIG. 1 shows an optical waveguide structure constituted of a Si substrate 1, a SiO₂ underlying cladding layer 2 formed on the Si substrate 1, a pure quartz glass core layer 3 formed on the SiO₂ underlying cladding layer 2, and a SiO₂ overlying cladding layer 4 formed on the SiO₂ underlying cladding layer 2 and the pure quartz glass core layer 3 in such a manner as to bury the pure quartz glass core layer 3. The SiO₂ underlying cladding layer 2 and the SiO₂ overlying cladding layer 4 are doped with boron or fluorine.

However, the softening point of SiO₂ lowers with an increase in amount of the dopant. For this reason, when such quartz glass doped with boron or fluorine is used as the cladding layer, the cladding layer is softened at a lower temperature than with the pure quartz glass core layer 3. Accordingly, when a heat treatment according to the flame hydrolysis deposition method or the like is performed for stabilization of the film quality of the core film and flattening of the cladding layer during the optical waveguide manufacturing process, as shown in FIG. 1, the pure quartz glass core layer 3 with a high softening point sinks into the SiO₂ underlying cladding layer 2, which is rich in dopant and has a low softening point.

As a result, for example, a problem such as being unable to control the interval of the optical waveguide occurs, so that a desired optical circuit pattern cannot be formed, making it difficult to form a high performance optical circuit. Note that the softening point herein means the temperature at which a solid substance starts to be softened and deformed when heated, and, for example, is a value of about 1600° C. for pure quartz glass, and a value of about 900° C. for dopant-rich and low-softening-point SiO₂ cladding layer.

Under such circumstances, a method has conventionally been proposed, wherein a very thin core film is left at the bottom surface of the core having a rectangular cross sectional shape, so that the core layer is floated by the surface tension; this suppresses the core layer from sinking into the underlying cladding layer in the heat treatment of the manufacturing process (see, e.g., PTL 2).

FIG. 2 shows a conventional optical waveguide structure shown in PTL 2. FIG. 2 shows an optical waveguide structure constituted of a thin core film 15 disposed on the SiO₂ underlying cladding layer 12 and under a pure quartz glass core layer 13 in addition to the Si substrate 11, the SiO₂ underlying cladding layer 12 formed on the Si substrate 11, the pure quartz glass core layer 13, and the SiO₂ overlying cladding layer 14 formed on the SiO₂ underlying cladding layer 12 and the pure quartz glass core layer 13 in such a manner as to bury the pure quartz glass core layer 13. Herein, the SiO₂ underlying cladding layer 12 and the SiO₂ overlying cladding layer 14 are doped with boron or fluorine as with FIG. 1.

With the conventional optical waveguide structure shown in FIG. 2, when the circuit pattern of the pure quartz glass core layer 13 is formed by etching, etching is performed so as to leave a very thin core film 15 at the rectangular pure quartz glass core layer 13 bottom surface. The formation of the core film 15 floats the pure quartz glass core layer 13 even when the surface tension received by the core film 15 softens the cladding layer. This suppresses the pure quartz glass core layer 13 from sinking into the SiO₂ underlying cladding layer 12 in the heat treatment of the manufacturing process.

### CITATION LIST

### Patent Literature

[PTL 1] Japanese Patent Application Publication No. 2013-171261
[PTL 2] Japanese Patent Application Publication No. 2006-030734

### SUMMARY OF THE INVENTION

### Technical Problem

With the conventional waveguide structure shown in FIG. 2, the film thickness of the core film 15 to be left upon etching of the pure quartz glass core layer 13 is controlled, thereby achieving a thinner film.

However, when the thin core film 15 is tried to be left on the SiO₂ underlying cladding layer 12 by etching, the microloading effect that the etching rate changes according to the density of the circuit pattern is caused. The microloading effect results in a decrease in etching rate in the area where the circuit patterns are densely disposed, and results in an increase in etching rate in the area where the circuit patterns are sparsely disposed. Accordingly, it has been undesirably difficult to control the core film 15 to have a uniform residual thickness in the wafer plane.

Further, the etching rate varies within the substrate plane, thereby resulting in variations in residual thickness of the core film 15 within the plane. This also undesirably causes the reduction of the yield.

The present invention was completed in view of the foregoing problem. It is an object of the present invention to provide an optical wavelength suppressed in sinking of the core layer into the underlying cladding layer in the heat treatment, thereby enabling the reduction of the loss of the visible light waveguide, and capable of suppressing the reduction of the yield due to the variations within the substrate plane of the etching rate.

### Means for Solving the Problem

In order to solve the problem, in accordance with one aspect of an optical waveguide of the present invention, it is characterized in that a thin etching stopping layer formed of a different material from that of a core layer is disposed under the core layer.

Further, the present invention is characterized by having the following specific constitutions.

### (Constitution 1)

An optical waveguide, including: a substrate, an underlying cladding layer formed on the substrate, an etching stopping layer formed on the underlying cladding layer, a core layer formed on the etching stopping layer, and an overlying cladding layer formed on the core layer and the etching stopping layer, characterized in that the etching stopping layer includes a material having a smaller etching rate than that of a material forming the core layer, and having a higher softening point than that of the material forming the core layer.

### (Constitution 2)

The optical waveguide according to the constitution 1, characterized in that the thickness of the etching stopping layer is a thickness of 2% or less of that of the core layer.

### (Constitution 3)

The optical waveguide according to the constitution 1 or 2, characterized in that the etching stopping layer includes a material including aluminum oxide (Al₂O₃), magnesium oxide (MgO), yttrium oxide (Y₂O₃), or yttrium aluminum garnet (YAG).

### (Constitution 4)

The optical waveguide according to any one of the constitutions 1 to 3, characterized in that the core layer includes pure quartz glass.

### (Constitution 5)

The optical waveguide according to any one of the constitutions 1 to 4, characterized in that the underlying cladding layer and the overlying cladding layer include quartz-based glass doped with boron or fluorine.

### (Constitution 6)

A method for manufacturing an optical waveguide, including the steps of: forming an underlying cladding layer on a substrate, forming an etching stopping layer on the underlying cladding layer, forming a core layer on the etching stopping layer, and forming an overlying cladding layer on the core layer and the etching stopping layer, characterized in that the etching stopping layer is formed of a material having a smaller etching rate than that of a material forming the core layer, and having a higher softening point than that of the material forming the core layer.

### (Constitution 7)

The method for manufacturing an optical waveguide according to the constitution 6, characterized in that the etching stopping layer is formed with a thickness of 2% or less of the thickness of the core layer.

### (Constitution 8)

The method for manufacturing an optical waveguide according to the constitution 6 or 7, characterized in that the etching stopping layer is formed of a material including aluminum oxide (Al₂O₃), magnesium oxide (MgO), yttrium oxide (Y₂O₃), or yttrium aluminum garnet (YAG).

### Effects of the Invention

As described up to this point, in accordance with the present invention, it becomes possible to provide an optical wavelength suppressed in sinking of the core layer into the underlying cladding layer in the heat treatment of the manufacturing process, thereby enabling the reduction of the loss of the visible light waveguide, and suppressed in in-plane variations in the waveguide shape due to the microloading effect or the in-plane distribution of the etching rate.

### BRIEF DESCRIPTION OF DRAWINGS

FIG. 1 is a substrate cross sectional view showing one example of a conventional optical waveguide structure.

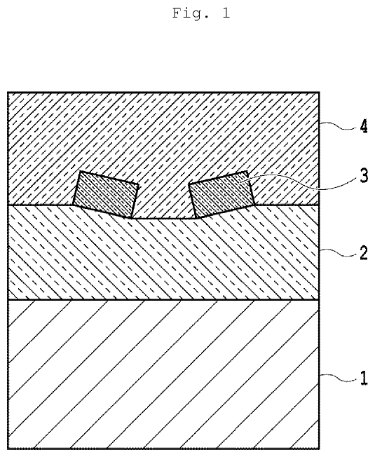

FIG. 2 is a substrate cross sectional view showing another example of a conventional optical waveguide structure.

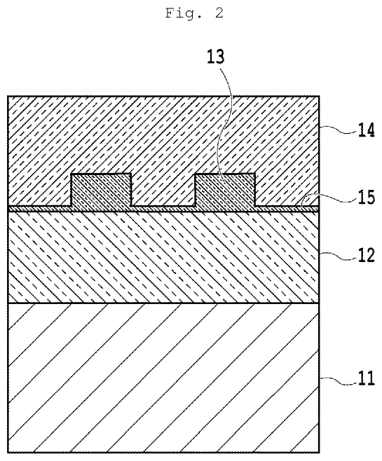

FIG. 3 is a substrate cross sectional view showing an optical waveguide structure in accordance with an embodiment of the present invention.

### DESCRIPTION OF EMBODIMENTS

Embodiments of the present invention will be described below, in details with reference to the accompanying drawings.

### (Optical Waveguide Structure)

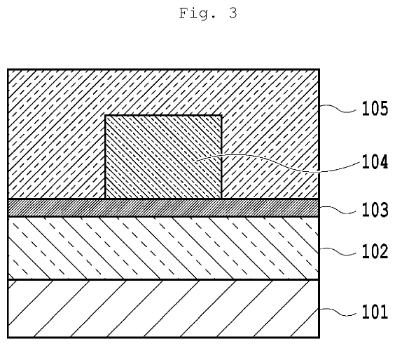

FIG. 3 is a substrate cross sectional view showing an optical waveguide structure in accordance with an embodiment of the present invention. FIG. 3 shows an optical waveguide structure constituted of a substrate 101 constituted of, for example, Si, an underlying cladding layer 102 formed on the substrate 101, and constituted of, for example, quartz-based glass, an etching stopping layer 103 formed on the underlying cladding layer 102, and constituted of, for example, aluminum oxide (Al₂O₃), a core layer 104 formed on the etching stopping layer 103, and constituted of, for example, pure quartz glass, and an overlying cladding layer 105 formed on the core layer 104, and constituted of, for example, quartz-based glass.

The underlying clad 102 and the overlying cladding layer 105 include quartz-based glass doped with, for example, fluorine so that the specific refractive index difference A becomes about 2% as compared with the material forming the core layer 104.

The etching stopping layer 103 desirably has a thickness large enough for floating the core layer 104 by the surface tension, and so thin as to prevent the peak of distribution of the electric field strength in the direction in the cross section (e.g., the vertical direction of the drawing) of the waveguide of a propagation light propagating through the optical waveguide from transferring from the core layer 104 to the etching stopping layer 103, and can have a thickness of, for example, 2% or less of the thickness of the core layer 104. The lower limit of the etching stopping layer is determined depending on the film thickness controllability during deposition, and is roughly about 0.01 μm.

### (Manufacturing Method of Optical Waveguide)

A description will be given below on a method for manufacturing an optical waveguide in accordance with an embodiment of the present invention. First, on a substrate 101 having a thickness of 1 mm, and constituted of, for example, Si, fluorine-doped SiO₂ is deposited by 20 μm using, for example, the flame hydrolysis deposition method, thereby forming an underlying cladding layer 102.

Then, on the underlying cladding layer 102, using, for example, the ALD (Atomic Layer Deposition) method, aluminum oxide is deposited by 0.02 μm, thereby forming an etching stopping layer 103. Subsequently, on the etching stopping layer 103, using, for example, a sputtering method, a pure quartz glass film is deposited by 1 μm. The pure quartz glass film is etched in a desired optical circuit pattern in a rectangular shape in the substrate cross section, thereby forming a core layer 104.

Subsequently, using, for example, the flame hydrolysis deposition method, SiO₂ doped with fluorine so as to achieve a refractive index equal to that of the underlying cladding layer 102 is deposited by 20 μm, thereby forming an overlying cladding layer 105.

With an optical waveguide in accordance with the present embodiment, with dry etching upon core formation using a fluorine type gas, etching is stopped at an aluminum oxide layer of the etching stopping layer 103. This enables the etching amount of the pure quartz glass film to be made constant, which can suppress the in-plane variations in the shape of the core layer 104 due to the microloading effect or the in-plane distribution of the etching rate. Further, the softening point of aluminum oxide of the etching stopping layer is higher than the softening point of quartz-based glass. For this reason, softening is not caused at the time of a heat treatment, so that the core layer 104 can be floated by the surface tension, which enables suppression of sinking into the underlying clad 102.

Note that, in the example, the underlying cladding layer 102 and the overlying cladding layer 105 are deposited with a flame hydrolysis deposition method; and the core layer 104, with a sputtering method. The deposition method may be freely selected from a flame hydrolysis deposition method, a chemical vapor deposition method, and a sputtering method.

In the example, the substrate 101 includes Si, and may include any material so long as the material desirably has a melting point of 1400° C. or more, and a coefficient of thermal expansion of 0.5×10⁻⁶/° C. or more.

Further, in the example, the underlying cladding layer 102 and the overlying cladding layer 105 are constituted of SiO₂ doped with fluorine. As the dopant, boron or fluorine, or both thereof may be used, and the specific refractive index difference A from the core is not required to be 2%.

Further, in the example, the etching stopping layer 103 includes aluminum oxide (Al₂O₃), and may also include a material including, for example, magnesium oxide (MgO), yttrium oxide (Y₂O₃), or yttrium aluminum garnet (YAG). The material and the thickness of the etching stopping layer 103 are selected from the materials having a smaller etching rate than that of the core layer 104 with respect to the etching gas for use in forming the core layer 104 of the waveguide, and having a softening point or a melting point higher than that of the core layer 104, and a film thickness capable of allowing the core layer 104 to be floated by the surface tension, respectively.

Further, in the example, the overlying cladding layer 105 was configured so that the refractive index thereof becomes the same as the refractive index of the underlying cladding layer 102. When the refractive index is lower than the refractive index of the core layer 104, it may be configured such that the underlying cladding layer 102 and the overlying cladding layer 105 have different refractive indexes. Further, the underlying cladding layer 102 and the overlying cladding layer 105 may be the same or different.

### INDUSTRIAL APPLICABILITY

In accordance with the present invention, it becomes possible to provide an optical wavelength suppressed in sinking of the core layer into the underlying cladding layer in the heat treatment of the manufacturing process, thereby enabling the reduction of the loss of the visible light waveguide, and an optical waveguide with suppressed in-plane variations in the optical waveguide shape can be provided.

### REFERENCE SIGNS LIST

1, 11 Si substrate
2, 12 SiO₂ underlying cladding layer
3, 13 Pure quartz glass core layer
4, 14 SiO₂ overlying cladding layer
15 Core film
101 Substrate
102 Underlying cladding layer
103 Etching stopping layer
104 Core layer
105 Overlying cladding layer

1. An optical waveguide, comprising: a substrate, an underlying cladding layer formed on the substrate, an etching stopping layer formed on the underlying cladding layer, a core layer formed on the etching stopping layer, and an overlying cladding layer formed on the core layer and the etching stopping layer, wherein the etching stopping layer includes a material having a smaller etching rate than that of a material forming the core layer, and having a higher softening point than that of the material forming the core layer.

2. The optical waveguide according to claim 1, wherein the thickness of the etching stopping layer is a thickness of 2% or less of that of the core layer.

3. The optical waveguide according to claim 1 or 2, wherein the etching stopping layer includes a material including aluminum oxide (Al₂O₃), magnesium oxide (MgO), yttrium oxide (Y₂O₃), or yttrium aluminum garnet (YAG).

4. The optical waveguide according to any one of claims 1 to 3, wherein the core layer includes pure quartz glass.

5. The optical waveguide according to any one of claims 1 to 4, wherein the underlying cladding layer and the overlying cladding layer each include quartz-based glass doped with boron or fluorine.

6. A method for manufacturing an optical waveguide, comprising the steps of: forming an underlying cladding layer on a substrate, forming an etching stopping layer on the underlying cladding layer, forming a core layer on the etching stopping layer, and forming an overlying cladding layer on the core layer and the etching stopping layer, wherein the etching stopping layer is formed of a material having a smaller etching rate than that of a material forming the core layer, and having a higher softening point than that of the material forming the core layer.

7. The method for manufacturing an optical waveguide according to claim 6, wherein the etching stopping layer is formed with a thickness of 2% or less of the thickness of the core layer.

8. The method for manufacturing an optical waveguide according to claim 6 or 7, wherein the etching stopping layer is formed of a material including aluminum oxide (Al₂O₃), magnesium oxide (MgO), yttrium oxide (Y₂O₃), or yttrium aluminum garnet (YAG).
